(19) United States
(12) Patent Application Publication
(10) Pub. No.: US 2006/0176650 A1
(43) Pub. Date: Aug. 10, 2006

(54) FLEXIBLE ARMORED WIRING

(75) Inventor: John T. Hogan, Detroit, MI (US)

Correspondence Address: DOBRUSIN & THENNISCH PC, 29 W LAWRENCE ST, SUITE 210, PONTIAC, MI, 48326, US

(73) Assignee: Jada Technologies

(21) Appl. No.: 11/382,389

(22) Filed: May 9, 2006

Related U.S. Application Data
(60) Provisional application No. 60/679,062, filed on May 9, 2005.

(51) Int. Cl. H02B 1/00

(52) U.S. Cl. 361/600

(57) ABSTRACT

The present invention relates to a system, method and device for protecting wiring and wiring assemblies from forces commonly occurred during accidents such as blunt forces, fire, or otherwise.

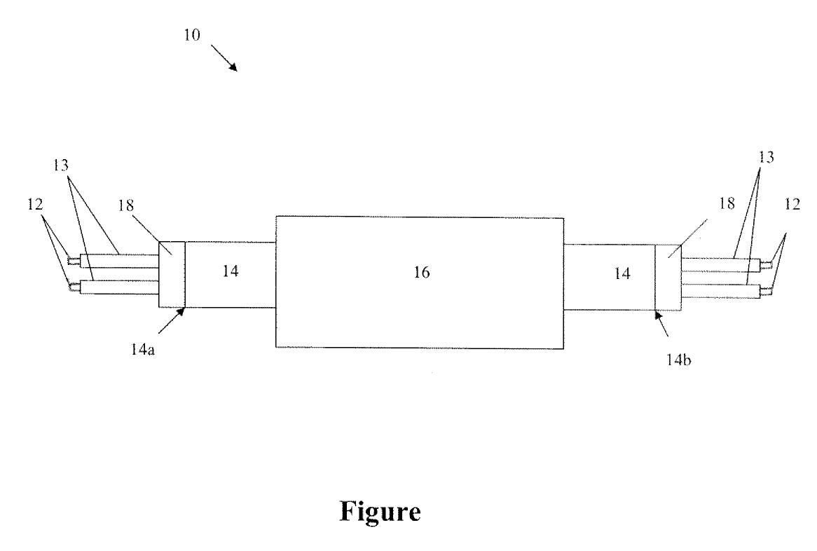

### PRIORITY CLAIM

To the extent applicable, the present invention claims the benefit of the priority of U.S. Provisional Application Ser. No. 60/679,062, filed May 9, 2005, the contents of which are incorporated by reference herein.

### FIELD OF THE INVENTION

The present invention generally relates to wiring and wiring assemblies. More particularly, it relates to protective mechanisms for such wiring and wiring assemblies.

### BACKGROUND OF THE INVENTION

Wiring and wiring assemblies provide highly needed functionality across many applications and across many environments. Due to its critical functionality, there is a significance interest in sustaining wiring integrity. To address these issues, damage prevention and deterrent means may be used to protect wire from damage. Further, fire prevention and suppression means may be used to prevent or minimize fire hazards and consequential damage.

Motorized vehicles and aircraft, and their wiring assemblies, may be particularly susceptible to fire and damage by virtue of their intended use as means of transportation. For example, police and emergency vehicles may provide services for chasing suspects or for transporting critically ill patients to emergency facilities. A substantial risk of impact to the vehicles exists due to such factors as the high rate of speed at which these vehicles travel; the environment through which the vehicle travels (for example, congested neighborhoods and roadways having high volumes of traffic); and the conditions under which the travel occurs (for example, inclement weather conditions).

Such impacts typically result in adverse consequences. The vehicle may sustain basic component damage. Further, damage to the components such as wiring may result electrical shorts, which may, in turn, cause fire damage, smoke damage, melting damage and cause or contribute to, for example, the ignition of flammable fluids such as gasoline.

For example, in an extreme impact to a police car, the crash sometimes results in the rupture of the fuel tank and extensively damages some of the battery wiring. Although both battery wires remain connected to their respective terminals, the wire connected to the positive terminal sustains enough damage that its other end contacts the chassis. In effect, the two terminals of the battery become “shorted” together via the chassis, and an extreme amount of current flows through the wire. The current begins to raise the temperature of the wire. Although the wire comprises an insulative outer layer in addition to the conductor, the extreme amount of current causes the wire to dissipate an amount of heat that completely melts the insulator and ignites everything that comes into contact with the conductor, such as fuel lines, other wires, plastics, etc. The resultant burn, in turn, ignites the gasoline fluids from the ruptured tank, causing an explosion and irreversible damage to the vehicle, as well as exposing occupants to the risk of severe bodily harm or death.

Although various protective coverings and coatings may be available to reduce or limit wiring damage, such coverings may provide insignificant benefits or may include serious drawbacks. For example, in extreme impact situations, metal coverings electrically short. Rigid metal conduits, such as those used to contain flame and smoke, may not facilitate the wiring flexibility required in intricate environments, such as engine compartments. HDLP and similar coatings fail to provide the durability and ruggedness necessary to protect the wiring.

As can be seen, an inability to provide fire and damage prevention and suppression solutions may pose substantial risk of property damage and harm to vehicle occupants and bystanders.

### SUMMARY OF THE INVENTION

The technology of the present invention may be directed to new and improved areas of fire prevention and suppression in various wiring components, subcomponents, and related assemblies, including, for example, vehicle wiring assemblies. The technology may include a variety of features and qualities, such as varying degrees of flexibility. Various aspects of the technology may include, but are not limited to, a layer of armor and an over-mold of heat resistant material.

In one aspect, the present invention provides an armored wire system comprising one or more electrically conductive wires, each of the one or more wires including a layer of insulation thereover. The system also includes a first layer encasing at least a portion of the one or more wires, the first layer comprising a flexible material that is resistant to tensile forces, shearing forces or both. The system also includes a second layer encasing at least a portion of the first layer, the second layer comprising a flexible material that is resistant to plastic deformation at elevated temperatures.

In another aspect, the present invention provides a method of forming an armored wire assembly, the method including the steps of: i) forming a sleeve of braided material, the sleeve forming an opening extending between a first and second end of the sleeve; ii) placing one or more wires within the braded material during formation of the same, the one or more wires including electrical insulation; and iii) forming an additional layer of heat resistant material over the sleeve.

Other aspects of the invention should be appreciated as described and shown herein.

### DESCRIPTIONS OF THE DRAWINGS

The one FIGURE illustrates schematic view of one embodiment of an armored wire system according to the teachings of the present invention

### DETAILED DESCRIPTION OF THE INVENTION

The present invention provides a system, method and device for protecting wires from damage, particularly from damage associated with or resulting from vehicle accidents. In doing so, the present invention provides an enclosure for such if wires that is resistant to rupture, shearing, heat, or other failure as a result of impact, fire or other results of an accident. Furthermore, the enclosure provides additional protection from dangerous conditions previously resulting exposed wires such as short circuit to an electrical system, sparks, fire or otherwise. This is particularly important when considering the flammable materials that may be exposed during or after an accident including: plastic, rubber, gasoline, oil, grease, fabric or otherwise.

In one aspect, the present invention provides protective layer (such as a sleeve, sheath, wrap or otherwise) that is configured for providing impact resistance and which covers a substantial portion of a given length of the wire. The layer includes or otherwise comprises an armored material that is resistant to failure such as rupturing, shearing, tearing, puncturing or otherwise, which may be encountered during a vehicle accident or otherwise Preferably, the cover comprises a flexible material which allows the enclosed wire to bend.

In another aspect, the present invention provides a heat resistant material configured to provide insulation to the cover a substantial portion of a given length of the wire, preferably substantially the entire wire. The heat resistant material is configured to resist plastic deformation, for a given time period, during exposure to increased temperature, typically those temperature encountered during a vehicle fire. Also, the material may be self-extinguishing and resistant to melting, dripping or running in the presence of fire or elevated temperatures. Preferably, the heat resistant material comprises a flexible material.

In still another aspect, the present invention provides both the impact resistance cover and the heat resistant material. In doing so, the present invention may provide a flexible, protective armored wire system for wiring and wiring assemblies with the benefits as described above. Accordingly, in various aspects of the technology, the armoring may provide varying degrees of impact resistance, varying degrees of temperature resistance, varying degrees of fire resistance, or combinations thereof. The resultant product is extremely tough and durable and that is proven capable of resisting the extreme physical challenges of an accident but still remain flexible enough to be folded and ran throughout a vehicle or otherwise.

As an example of the forgoing, referring to the FIGURE, one example of an armored wire system 10 of the present invention is shown. In this configuration, the system includes one or more wires or wire assemblies 12. Surrounding the wires, the system also includes one or more layers of protective armored material 14 and one or more layers of heat resistant over-mold material 16. It will become apparent the other features and configurations are available, as described herein. Also, it is contemplated that in one configuration, except of the wiring located therein, the system is substantially free of electrically conductive material, such as metal or otherwise.

Applications

The protection system may be used in numerous applications. Particularly, the system may be advantageously used where it is contemplated that the system may be exposed to the application of force, particularly blunt force, through shearing, tensile, friction, or otherwise. Examples of when such forces may be encountered include vehicle crashes (e.g. automobile, trucks, airplanes, helicopters, trains, ships, boats or otherwise). Accordingly, it is contemplated that the system of the present invention may be used throughout the vehicle industry as just described. However, other dynamic systems are contemplated.

In one particular application, the system may be used with vehicles which are more prevalent to accidents. Such vehicles includes police vehicles, ambulances, fire trucks, other rescue vehicles including aviation and land vehicle, racing vehicles or otherwise. In providing the system of the present invention, all or portion of the vehicles electrical system include enhanced protection from the aforementioned forces in the event of an accident. Advantageously, this allows some or all of the circuitry of the vehicle to remain intact and also prevents sparks and fire from forming as a result of the wires short circuiting (e.g., current flowing from the wire or wire assembly to another wire or wire assembly, or otherwise).

Under certain circumstances, it is contemplated that the above referenced vehicles, or otherwise, possess fire retardant systems for eliminating, reducing or preventing fire of vehicles. These systems often include one or more fire retardant dispensers located at one or more locations throughout the vehicle. Upon an indication of fire, accident, or both, the fire retardant dispenser are activated through a controller causing the dispensing of fire retardant material.

As should be appreciated, such fire retardant systems often use a circuitry to trigger the dispensing of fire retardant materials. However, the fire retardant system may fail if the circuit is open at one or more locations, meaning that there is a break in the conductive lines within the system, which may be the result of an accident, fire or otherwise. Accordingly, in one particular application, the protective system may be used to protect various components of the circuit used to form a fire retardant system, particularly the wires and associated components.

Wires

As previously mentioned, the technology of the present invention, in various aspects, is typically associated with wires and wiring assemblies. Typical wires and wiring assemblies may generally comprise, for example, an electrical conductor and may include various types, sizes, features, materials, components or subcomponents, such as an insulative coating, or otherwise

For example, it is contemplated that the present invention may be configured to provide protection to vehicle wire configurations, particularly those wire configurations used in the automotive or other vehicle industry. Accordingly, it is contemplated that the invention may be configured to protect one or more electrically conductive wire or wire assemblies of an automobile or other vehicle, which operates within the voltage and current rating of the vehicle system.

In one configuration, the present invention may be configured to protect a single solid wire or single stranded wire. The phrase stranded wire may include a plurality of wires that are braided, wrapped, twisted or is otherwise conductively grouped together. The stranded wire may be twisted at a rate commonly used in the industry of conductive wire forming. The single wire or stranded wire may comprise any number of gauge size including 0000 to 50 gauge wire, or more typically 10 to 24 gauge. However, in one configuration, the wire gauge may comprise 18 gauge. Based upon the gauge and density of wire or stranded wire, the wire may include different weights per unit length.

The wire may be formed of common conductive material which is preferably electrically conductive. It should be appreciated that any suitable wire may be used or protected with the system of the present invention. However, in one configuration the wire comprises or otherwise includes copper. Also, it is contemplated that the wire may include an insulative layer, coating, sleeve or otherwise to substantially preventing current exiting the wire at an unintended location (e.g. short or otherwise).

In another configuration, as shown in the FIGURE, the wiring system may include two or more wires 12. In this configuration, it is contemplated that each of the wires may comprise any of the features or characteristics as discussed in the single wire or stranded wire configuration. Preferably, the wires are separated to substantially prevent current flowing therebetween and more preferably, the wire includes an insulative layer 13 therebetween. The wires may be twisted together at various rates for assisting in manufacturing of the system of the present invention or otherwise.

One example of the foregoing includes, but not limited thereto, two seven-strand copper wire assemblies configured as twisted pair, each having one twist per inch. The two wires may be further bundled with like or differing wires, or may be otherwise configured. Another example of the foregoing includes, for example, two 18 gauge wires having a diameter of approximately 11.75 mm, wherein an 1170 mm wire has a weight of approximately 0.1077 kg. For purposes of clarity, all types, sizes, configurations, and combinations of wires and wiring assemblies may be used.

Optionally, the wires may include additional features for providing attachment of the wire to other components, or otherwise Such features may include connectors such as pins for insertion into corresponding openings or eyelets for attachment to another component via a fastener, harnesses, or otherwise.

Armor Protective Layer

The system also includes a protective layer, such as an armored layer, for protection of the enclosed wires. As previously mentioned, the protective layer is configured to resist failure such as rupture, shearing, tearing, puncture or otherwise, which may be encountered during a vehicle accident or otherwise.

The protective armor layer may comprise one or more materials, which may be layered and/or integrated together. Preferably, the material includes, for example, one or more properties such as extremely high breaking strength, durability, lightweight qualities, and flexibility. Also it is preferred that the material is configured to withstand elevated temperatures. Still further, in one configuration, the protective layer is substantially free of electrically conductive material, such as metal or otherwise.

One such material may comprise or include, for example, a polyaromatic amide fiber, such as that found in KEVLAR™ provided by DuPont™, which may exhibit superior resistance to abrasion and impact damage. Other materials may also be used such as throse found in materials such as Twaron™, Technora™, or otherwise. Such materials are typically formed into fiber strands and woven together as described herein.

In one configuration, the fiber material forming the protective layer is braided into a tubular or sleeve structure, which may enclose or encase all or a portion of the wiring. The tubular or sleeve structure includes an opening formed therethrough for receiving the one or more wires. The opening extends between a first end 14a and a second end 14b of the tubular or sleeve structure. Fibers of the material may be braided into rope-like strands, after which the rope-like strands may be braided together in a weaving manner over the wire. Other braiding configurations are contemplated.

As previously mentioned, it is contemplated that the protective or armor layer may be formed, via braiding of polyaromatic amide fiber. The braids may have a predetermined thickness, based upon the number of braids over the number of braids. For example, the thickness of the braids may be based on the number of fiber strands grouped and woven together and the number of groups that are subsequently woven together. In one configuration, it is contemplated that the braids may comprise B29/24, where B29/24 refers to the number of fiber strands grouped and woven and the second number refers to the number of woven groups that are subsequently woven together. This resulting grouping is then used to weave the protective layer. While the above referenced braid configuration demonstrates one configuration, it should be appreciated that other configurations including more or less fibers strands and groupings may be used. In this manner, the armor layer may sustain its high strength and resistance to impact damage, yet remain flexible enough to facilitate complex wiring environments.

The size and strength of the tubular or sleeve structure may be based upon the design constraints of the given application. For example, the different size and quantity of wires may require different diameters of the protective layer. Also, the amount of required strength needed for the protective layer or system may dictate the braiding configuration and thickness of the protective layer. In one example, the braiding configuration B29/24 may be used to form a protective tubular or sleeve layer having a 12 mm diameter for two twisted wires, In another example, the braiding configuration B29/24 may be used to form a protective tubular or sleeve layer having an 8 mm diameter for one wire. Similarly, the length of the protective layer may also be dependent upon the application. However, in one configuration it is contemplated that the tubular or sleeve structure covers a substantial or entire portion of the wire and optionally connector thereof. Other configurations should be appreciated.

Optionally, a protective layer or cover 18 may be applied to the first, second or both ends of the tubular or sleeve structure. The cover may provide several benfits including substantially limiting unintended materially from entering between the protective layer and wires. The cover may also assist in unraveling of the braided protective layer (particularly in the absence of heat resistant layer), or otherwise. The protective cover may cover ail or a portion of the opening formed by the tubular or sleeve structure. In one configuration, the protective layer or cover comprise electrical tape applied to the first or second ends or the armored layer. However, other configurations are available.

Over-Mold Heat Resistant Layer

The system also includes heat resistant material layer, such as over-mold 16, for providing protection to the enclosed wires from elevated temperatures. Preferably, the heat resistant material is configured for both fire and abrasion protection. The over-mold may comprise, for example, one or more materials and may vary according to application. In one configuration, the material comprises a thermoset plastic. The materials may also have characteristics of high temperature resistance, For example, it has been discovered that the heat resistant material is capable of withstanding an application of 70,000 BTUs (British Thermal Units) of heat for a time period of one minute, without substantial plastic deformation (e.g., melting, dripping, running or otherwise). In one configuration, as with the protective layer, the heat resistant layer may be substantially free of electrically conductive material, such as metal or otherwise.

In one preferred configuration, the over-mold includes crossed-linked polyethylene (XLPE), such as found in ENVIRO-PLUS™ manufactured by Service Wire or similar material. However, other materials, such as crossed-linked polyolefin (XPE), may also be used. These types of materials may be self-extinguishing and resistant to melting, dripping or running, which may prevent the spread of fire to other surfaces and which may allow the components within the heat resistant over-mold layer to remain intact for longer periods of time, Further, the crossed-linked polyethylene or similar materials may be resistant to abrasion and impact damages, temperature tolerant in low-temperature environments and in high temperature environments; and easily handled, stored and installed, and thus may ensure structural and circuitry integrity.

In use, the Enviro-Plus cables pass the IEEE 383 and IEEE/FT4 1202 flame test and UL's direct Burial Crush Test. Furthermore, the over-mold material may include Durometer Hardness value of 88 (Shore A), passes ASTM D1044 Abrasion Test (1000 cycle) and passes the crush and impact test as specified by UL at −40° C. which allows cable to be used in low temperature environments.

As with the protective layer, the size and shape of the heat resistant material may also vary depending upon a given application. The length of the heat resistant material may extend substantially the entire length of the protective layer or wires therein. However, in one configuration, it is contemplated that the heat resistant layer may extend less than the entire length of the protective layer. For example, when protection of heat is not necessarily required at or along a certain portion of the system, that portion of the system may not have heat resistant material, or a reduction amount thereof. This may be the case where the system is attached to brackets, harnesses, or otherwise. Similarly, the thickness of the heat resistant material may also vary depending on the application. In one configuration, the thickness is approximately one half millimeter. However, in certain applications the thickness may be more or less, including one half to one millimeter, one millimeter or more.

Other Features

In one configuration, one or more components of the armored wire system 10 and of the wiring may, for example, vary in color or pattern to assist in visual identification of or differentiation between wires, bundles of wires, or the like.

In various aspects of the technology, the armored wire system may include also include, for example, the actual wiring, as well as related components and subcomponents, such as pins and connectors (not shown).

### EXAMPLE

Referring to the FIGURE, one example of the protective system 10 of the present invention is shown. The system shown includes two wires or wire assemblies 12 having insulation 13 thereover. Enclosing the wires, the system further includes a protective armored layer 14 comprising a tubular or sleeve structure forming an opening extending between a first 14a and second 14b end. Preferably, the layer and opening extends substantially the entire length of the wire.

Located over the protective layer, the system further includes a heat resistant layer 16, which may be over-molded to the protective layer. Optionally, the system further includes a protective cover 18 for closing all or a portion of the opening formed in or by the tubular or sleeve structure for providing protection to the wires located therein, preventing unraveling of the any braided protective layer, or otherwise

The resulting system of the present invention is capable of providing improved strength over other wire protecting configurations. In one configuration of the system, it has been discovered that the system is capable of withstanding more than 6000 Newtons of force during a generic pinch test before a short circuit was created, using the examples described herein. This was approximately more than 2000 Newtons more than previously known configurations. While one example has been shown, it should be appreciated that other configurations are available.

Forming Process

The present invention also contemplates a method of protecting one or more wires from forces as described herein. In one non-limiting example, the method includes protecting two wires that are used with an automotive vehicle.

At the onset, two wires or wire assemblies are provided each having an insulating coating layer. Preferably, the wires are twisted together. The insulated wires are feed or other wise placed through the armored layer as described herein. Optionally, the wires may be feed through an opening of the protective material as it is being formed (e.g. through a braiding process), wherein the protective material is formed about the wires.

Any suitable braiding machine may be used to braid the material of the protective layer into a tubular or sleeve structure. Example of suitable braiding machines include Wiring Harness Braiding Machine manufactured by Cobra, Rapid Braider manufactured by Wardwell Braiding Machine Company, or otherwise.

Optionally, upon substantially being formed about the wires, the ends of the protective layer or more specifically the opening formed by the protective layer for receiving the wires may be substantially closed to keep material, heat or otherwise from entering between the protective layer and the wires. This may result in the substantial encasement of the wires within the armored material.

The heat resistant over-mold material is applied to the protective layer, and hence about the wires through an extrusion process. An extruding process may be used to apply the heat resistant material to the protective layer. In doing so, an extruder melts the cross-linked polyethylene to the protective layer as the protective layer and wires are sent through, wherein the melted material forms around the protective layer. Optionally, a coating may be applied to the heat resistant material to provide further heat resistance or otherwise. The heat resistant material may vary in dimension and may be applied to substantially the entire length of the protective layer, wires or both. However, a skilled artisan will note that the foregoing is illustrative only, and not in any way limiting of the scope of the technology.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. An armored wire system comprising:
one or more electrically conductive wires, each of the one or more wires including a layer of insulation thereover;
a first layer encasing at least a portion of the one or more wires, the first layer comprising a flexible material that is resistant to tensile forces, shearing forces or both; and
a second layer encasing at least a portion of the first layer, the second layer comprising a flexible material that is resistant to plastic deformation at elevated temperatures.

2. The system of claim 1, wherein the system includes two electrically conductive wires.

3. The system of claim 1, wherein the first layer comprises a sleeve having an opening formed therethrough for receiving the one or more wires, the opening extending between a first end and a second end of the sleeve.

4. The system of claim 3, wherein the first layer includes a braided fiber material formed of a polymeric amide material.

5. The system of claim 3, wherein at least portion of the opening formed through the sleeve is covered with a protective cover at the first end of the sleeve, second end of the sleeve or both.

6. The system of claim 4, wherein the second layer is a thermoset plastic.

7. The system of claim 6, wherein the second layer is a crossed-linked polyethylene material.

8. The system of claim 7, wherein the first layer is substantially free of electrically conductive material.

9. The system of claim 1, wherein except for the one or more wires the system is substantially free of electrically conductive material.

10. The system of claim 1, wherein the first, second or both layers extend substantially the entire length of the one or more wires.

11. The system of claim 1, wherein the wire includes one or more connectors for connecting to an electrical component and wherein the first layer covers at least a portion of one of the one or more connectors.

12. An armored wire system comprising:
a first and a second electrically conductive wire, the first and second wire including insulation for substantially preventing electrical conductivity therebetween;
a first layer encasing at least a portion of the first and second wire, the first layer comprising a flexible sleeve formed of a braided polymeric amid material that is resistant to tensile force, shearing force or both; and
a second layer encasing at least a portion of the first layer, the second layer comprising a thermoset crossed-linked polyethylene material,
wherein the first layer extend substantially the entire length of the first and second wire, and
wherein the first and second layer is substantially free of electrically conductive material.

13. A method of forming an armored wire system, the method including the steps of:
i) forming a sleeve of braided material, the sleeve including an opening formed therein extending between a first and second end of the sleeve;
ii) placing one or more wires within the sleeve during forming of the same, the one or more wires including electrical insulation; and
iii) forming an additional layer of heat resistant material over the sleeve.

14. The method of claim 13, wherein the sleeve and heat resistant material is substantially free of electrically conductive material.

15. The method of claim 14, wherein the additional layer is extruded over the sleeve through an extruding process.

16. The method of claim 13, wherein the braided material includes stands of polymeric amide fiber.

17. The method of claim 13, further comprising the step of covering at least portion of the opening formed through the sleeve with a protective cover at the first end of the sleeve, second end of the sleeve or both.

18. The method of claim 13, wherein two wires are placed within the braided material during forming and wherein the electrical insulation is located between the two wires.

19. The method of claim 13, wherein except for the wires the resulting armored wire system is substantially free of electrically conductive material.

20. The method of claim 13, wherein the sleeve covers substantially the entire length of the one or more wires and wherein the resulting armored wire assembly is flexible.
